(19) United States
(12) Patent Application Publication
(10) Pub. No.: US 2008/0128641 A1
(43) Pub. Date: Jun. 5, 2008

(54) APPARATUS AND METHOD FOR INTRODUCING PARTICLES USING A RADIO FREQUENCY QUADRUPOLE LINEAR ACCELERATOR FOR SEMICONDUCTOR MATERIALS

(75) Inventors: Francois J. Henley, Aptos, CA (US); Albert Lamm, Suisun City, CA (US); Babak Adibi, Las Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Silicon Genesis Corporation, San Jose, CA (US)

(21) Appl. No.: 11/936,582

(22) Filed: Nov. 7, 2007

Related U.S. Application Data
(60) Provisional application No. 60/864,966, filed on Nov. 8, 2006.

(51) Int. Cl. G21K 5/10; H05H 9/00

(52) U.S. Cl. 250/492.21; 315/505

(57) ABSTRACT

A system for forming one or more detachable semiconductor films capable of being free-standing. The apparatus includes an ion source to generate a plurality of collimated charged particles at a first energy level. The system includes a linear accelerator having a plurality of modular radio frequency quadrupole (RFQ) elements numbered from 1 through N successively coupled to each other, where N is an integer greater than 1. The linear accelerator controls and accelerates the plurality of collimated charged particles at the first energy level into a beam of charge particles having a second energy level. RFQ element numbered 1 is operably coupled to the ion source. The system includes an exit aperture coupled to RFQ element numbered N of the RFQ linear accelerator. In a specific embodiment, the system includes a beam expander coupled to the exit aperture, the beam expander being configured to process the beam of charged particles at the second energy level into an expanded beam of charged particles. The system includes a process chamber coupled to the beam expander and a workpiece provided within the process chamber to be implanted

### CROSS-REFERENCE TO RELATED APPLICATION

The instant nonprovisional patent application claims priority to U.S. Provisional Patent Application No. 60/864,966, filed Nov. 8, 2006 and incorporated by reference in its entirety herein for all purposes.

### BACKGROUND OF THE INVENTION

Embodiments in accordance with the present invention relate generally to techniques including an apparatus and a method of introducing charged particles for semiconductor material processing. More particularly, embodiments of the present apparatus and method provide a system using a linear accelerator (Linac), such as a radio frequency quadrupole linear accelerator, to obtain a beam of particles with MeV energy level for manufacturing one or more detachable semiconductor film that is capable of free-standing for device applications including photovoltaic cells. But it will be recognized that the invention has a wider range of applicability; it can also be applied to other types of applications such as for three-dimensional packaging of integrated semiconductor devices, photonic or optoelectronic devices, piezoelectronic devices, flat panel displays, microelectromechanical systems (“MEMS”), nano-technology structures, sensors, actuators, integrated circuits, biological and biomedical devices, and the like.

From the beginning of time, human beings have relied upon the “sun” to derive almost all useful forms of energy. Such energy comes from petroleum, radiant, wood, and various forms of thermal energy. As merely an example, human being have relied heavily upon petroleum sources such as coal and gas for much of their needs. Unfortunately, such petroleum sources have become depleted and have lead to other problems. As a replacement, in part, solar energy has been proposed to reduce our reliance on petroleum sources. As merely an example, solar energy can be derived from “solar cells” commonly made of silicon.

The silicon solar cell generates electrical power when exposed to solar radiation from the sun. The radiation interacts with atoms of the silicon and forms electrons and holes that migrate to p-doped and n-doped regions in the silicon body and create voltage differentials and an electric current between the doped regions. Depending upon the application, solar cells have been integrated with concentrating elements to improve efficiency. As an example, solar radiation accumulates and focuses using concentrating elements that direct such radiation to one or more portions of active photovoltaic materials. Although effective, these solar cells still have many limitations.

As merely an example, solar cells rely upon starting materials such as silicon. Such silicon is often made using either polysilicon and/or single crystal silicon materials. These materials are often difficult to manufacture. Polysilicon cells are often formed by manufacturing polysilicon plates. Although these plates may be formed effectively, they do not possess optimum properties for highly effective solar cells. Single crystal silicon has suitable properties for high grade solar cells. Such single crystal silicon is, however, expensive and is also difficult to use for solar applications in an efficient and cost effective manner. Generally, thin-film solar cells are less expensive but less efficient than the more expensive bulk silicon cells made from single-crystal silicon substrates. Although successful, there are still many limitations with conventional techniques for forming solar cells or other films of materials.

From the above, it is seen that cost effective and efficient techniques for manufacturing of semiconductor materials are desirable.

### BRIEF SUMMARY OF THE INVENTION

The present invention relates generally to technique including an apparatus and a method of introducing charged particles for semiconductor material processing. More particularly, the present apparatus and method provide a system using a linear accelerator, such as a radio frequency quadrupole linear accelerator (RFQ Linac), to obtain a beam of particles with MeV energy level for manufacturing one or more detachable semiconductor film that is capable of free-standing for device applications including photovoltaic cells. But it will be recognized that the invention has a wider range of applicability; it can also be applied to other types of applications such as for three-dimensional packaging of integrated semiconductor devices, photonic or optoelectronic devices, piezoelectronic devices, flat panel displays, microelectromechanical systems (“MEMS”), nano-technology structures, sensors, actuators, integrated circuits, biological and biomedical devices, and the like.

In a specific embodiment, the present invention provides an apparatus for introducing charged particles for manufacture of one or more detachable semiconductor films capable of being free-standing for device applications. The apparatus includes ion source to generate a plurality of charged particles. The ion source can be an electron cyclotron resonance (ECR) or microwave ion source in a specific embodiment. The plurality of charged particles is collimated as a beam at a first energy level. Additionally, the apparatus includes a plurality of modular radio frequency quadrupole (RFQ) elements numbered from 1 through N, where N is an integer greater than 1. Each of the plurality of modular RFQ elements is coupled successively to each other to form a RFQ linear accelerator. The RFQ element numbered 1 is coupled to the ion source via a low energy beam extraction and focusing element. The apparatus controls and accelerates the beam of charged particles at the first energy through each of the plurality of modular RFQ Linac elements into a beam of charged particles having a second energy. The apparatus further includes an exit aperture coupled to the RFQ element numbered N of the RFQ linear accelerator. In a preferred embodiment, the apparatus includes a beam expander, potential beam shaping optics, mass analysis, and/or a beam scanner coupled to the exit aperture to provide an expanded and shaped beam of charged particles. In a specific embodiment, a workpiece including a surface region is provided. The workpiece can be implanted using the expanded beam of charged particles at the second energy to provide a plurality of impurity particles at a depth within the thickness of the workpiece. The plurality of impurity particles forms a cleave region at a depth greater than about 20 microns, and possibly greater than about 50 microns, from the surface region in a specific embodiment.

In an alternative specific embodiment, the present invention provides an apparatus for introducing charged particles for manufacture of one or more detachable semiconductor material capable of being free-standing for device applications. The apparatus includes an ion source to generate a first plurality of collimated charged particles. The first plurality of collimated charged particles are provided at a first energy level. The apparatus further includes a radio frequency quadrupole (RFQ) linac subsystem for focusing and accelerating the first plurality of charged particles having a first energy level to a beam having a second energy level. Additionally, the apparatus includes a plurality of modular rf quadrupole/drift-tube (RQD) elements numbered from 1 through N successively coupled to each other. N is an integer greater than 1. In a specific embodiment, element numbered 1 is coupled to the RFQ linac subsystem. Each of the plurality of modular RQD elements comprises a two-part drift-tube along the longitudinal axis of a cylindrical hollow structure where each part of the two-part drift-tube is supported by a radial stem, both major and minor and has two rods pointed towards opposite end of the two-part drift-tube to from a rf quadrupole. A spatial gap between the two-part drift-tubes of neighboring RQD elements is properly increased for accelerating the beam having the second energy level through each of the plurality of modular RQD elements into a beam having a third energy level. The apparatus further includes an exit aperture coupled to the RQD element numbered N. In a preferred embodiment, the apparatus includes a beam expander, shaper, and mass analysis optical elements coupled to the exit aperture. The beam expander is configured to process the beam at the third energy level into an expanded beam size capable of implanting the plurality of charged particles. The apparatus according to the present invention includes a process chamber operably coupled to the beam expander. A workpiece including a surface region is provided within the process chamber. The workpiece includes the surface region can be implanted using the plurality of particles at the third energy level in a specific embodiment. Preferably, the plurality of impurity particles forms a cleave region at a depth of greater than about 20 microns, and possibly greater than about 50 microns, from the surface region of the workpiece.

In yet an alternative specific embodiment, the present invention provides a method for introducing charged particles for manufacture of one or more detachable semiconductor films capable of being free-standing for device applications. The method includes generating a beam of charged particles with a beam current at a first energy level using an ion source. Additionally, the method includes transferring the beam at a first energy level to a beam at a second energy level through a radio frequency quadrupole (RFQ) linear accelerator coupled to the ion source. The RFQ linear accelerator comprises a plurality of modular RFQ elements numbered 1 to N, where N is an integer greater than 1. The method further includes processing the beam at the second energy level with a beam expander coupled to the RFQ linear accelerator to expand the beam size capable of implanting the charges particles. Moreover the method includes irradiating the beam at the second energy level into a workpiece through a surface region. The workpiece is mounted in a process chamber which is coupled to the beam expander in such a way that the beam at the second energy level with a certain beam size can scan across the surface region and can create a cleave region with an averaged implantation dose at a depth of greater than about 20 microns, and possibly greater than about 50 microns, from the surface region of the workpiece.

In yet other alternatives according to embodiments of the present invention, the charged particle beam is accelerated to above 1 MeV up to 5 MeV using a cost effective linear accelerator system. Such linear accelerator system may include radio frequency quadrupole or a drift-tube, or a combination thereof to provide a charged particle beam. The charged particle beam can be further expanded, that is, its beam diameter can be increased using a beam expander coupled to an exit aperture of the linear accelerator system. The expanded beam is a high energy beam of charged particles with a controlled dose rate for implanting into the workpiece. The workpiece can be one or more tile-shaped semiconductor materials mounted in a tray device within a process chamber operably coupled to the beam expander. The workpiece can be implanted using the expanded beam of high energy charged particles at a depth within the thickness of the workpiece. The plurality of impurity particles forms a cleave region at a depth from the surface region to define a thickness of detachable material in a specific embodiment. The thickness of detachable material can a thickness greater than about 20 microns, and possibly greater than about 50 microns, in a specific embodiment. Of course, there can be other variations, modifications, and alternatives.

Numerous benefits are achieved over pre-existing techniques using embodiments of the present invention. In particular, embodiments of the present invention use an apparatus and method including using a cost effective linear accelerator system and a beam expander to provide a particle beam for high-energy implant process for thick layer transfer techniques. Such linear accelerator system may include, but is not limited to, a drift tube technique, a Radio Frequency Quadrupole, commonly called RFQ, Radio Frequency Interdigited (commonly known as RFI), or other linear acceleration methods, or combinations of these, and other suitable techniques. In a specific embodiment, the apparatus includes a beam expander that provides a beam with desired power flux sufficiently lower than a minimum flux to causing the excessive damage to the material to be implanted but high enough to uniformly apply on workpiece in square meter size or like with an efficient process. In a preferred embodiment, the linear accelerator system provides an implantation process that forms a thickness of transferable material defined by a cleave plane in a donor substrate. The thickness of transferable material may be further processed to provide a high quality semiconductor material for application such as photovoltaic devices, 3D MEMS or integrated circuits, IC packaging, semiconductor devices, any combination of these, and others. In a preferred embodiment, the present method provides for single crystal silicon thick film for highly efficient photovoltaic cells among others. An alternative preferred embodiment according to the present invention may provide for a seed layer that can further provide for layering of a hetero-structure epitaxial process. The hetero-structure epitaxial process can be used to form thin multi-junction photovoltaic cells, among others. Merely as an example, GaAs and GaInP layers may be deposited heteroepitaxially onto a germanium seed layer, which is a transferred layer formed using an implant process according to an embodiment of the present invention. Depending upon the embodiment, one or more of these benefits may be achieved.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

FIG. 1 is a simplified diagram illustrating an apparatus for introducing a charged particle beam for making a detachable free-standing film of semiconductor materials according to an embodiment of the present invention;

FIG. 2 is a simplified flow diagram illustrating a method of generating a plurality of high energy charged particles according to embodiments of present invention;

FIG. 3 is a simplified diagram illustrating a top view diagram of forming detachable thick film from a substrate according to an embodiment of the present invention;

FIG. 4 is a simplified diagram illustrating a method of implanting charged particles into a semiconductor material according to an embodiment of the present invention;

FIG. 5 are simplified diagrams illustrating a free-standing film formed by a cleave process from a semiconductor substrate according to an embodiment of the present invention;

FIG. 6 is a simplified diagram illustrating a method of forming a detachable thick film from a semiconductor substrate according to an embodiment of the present invention.

FIG. 7 is a simplified schematic diagram illustrating components of an embodiment of an apparatus for performing implantation according to the present invention.

FIG. 7A shows an enlarged schematic view of the ion source and low energy beam transport section of the apparatus of FIG. 7.

FIG. 7B shows an enlarged schematic view of the linear accelerator of the apparatus of FIG. 7.

FIG. 7C shows an enlarged schematic view of the beam scanning device of the apparatus of FIG. 7.

FIGS. 7D-G show various plots of simulated scanning of a high energy ion beam over a surface of a workpiece according to an embodiment of the present invention.

FIG. 8 is a schematic illustration of a computer system for use in accordance with embodiments of the present invention.

FIG. 8A is an illustration of basic subsystems the computer system of FIG. 8.

### DETAILED DESCRIPTION OF THE INVENTION

The present invention relates generally to techniques including an apparatus and a method of introducing charged particles for semiconductor material processing. More particularly, the present apparatus and method provide a system using a linear accelerator, for example a radio frequency quadrupole linear accelerator, to obtain a beam of particles with MeV energy level for manufacturing one or more detachable semiconductor film that is capable of free-standing for device applications including photovoltaic cells. But it will be recognized that the invention has a wider range of applicability; it can also be applied to other types of applications such as for three-dimensional packaging of integrated semiconductor devices, photonic or optoelectronic devices, piezoelectronic devices, flat panel displays, microelectromechanical systems (“MEMS”), nano-technology structures, sensors, actuators, integrated circuits, biological and biomedical devices, and the like.

For purposes of the following disclosure, a “free standing film” or “free standing layer” is defined as a film of material that can maintain its structural integrity (i.e not crumble or break apart), without being in contact with a supporting member such as a handle or transfer substrate at all times. Typically, very thin films (for example silicon films thinner than about 5-10 μm) are unable to be handled without breaking. Conventionally, such thin films are manipulated using a supporting structure, which may also be needed to create the thin film in the first place. Handling of thicker films (i.e. silicon films having a thickness of between 20-50 m) may be facilitated by the use of a support, but such a support is not mandatory. Accordingly embodiments of the present invention relate the fabrication of free standing films of silicon having a thickness of greater than 20 μm.

Embodiments in accordance with the present invention are not limited to forming free standing films. Alternative embodiments may involve the formation of films supported by a substrate. Moreover, irrespective of whether the films used in solar photovoltaic applications are truly free-standing or supported with handling or transfer substrates during photovoltaic cell processing, processed cells are usually mounted onto a mechanical surface such as glass or plastic for the final application as an integral part of a photovoltaic module.

Also for purposes of the following disclosure, “bulk material” refers to a material present in bulk form. Examples of such bulk material include a substantially circular ingot or boule of single crystal silicon or other similar materials as grown, or a grown single crystal silicon ingot or other similar materials having sides shaved to exhibit other than a substantially circular cross-sectional profile. Other examples of bulk materials include polycrystalline silicon plates or tiles exhibiting a square, rectangular, or trapezoidal profile. Still other examples of bulk materials are described below.

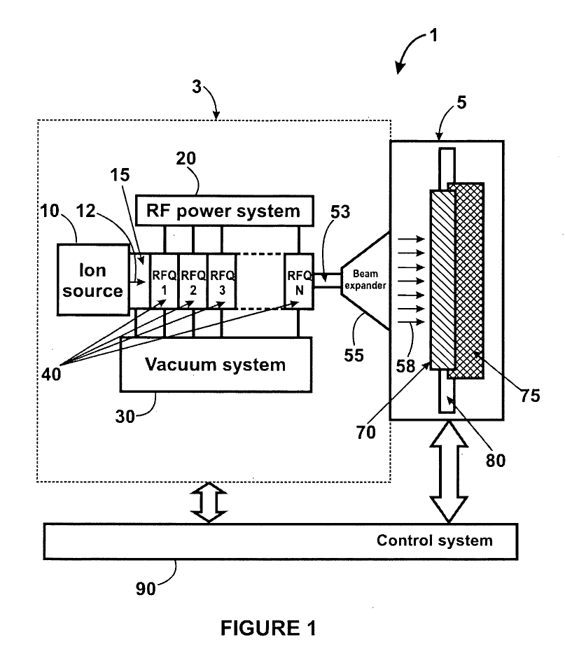

FIG. 1 is a simplified diagram illustrating an apparatus for introducing charged particles for manufacture of a detachable free-standing film of semiconductor materials for device applications according to an embodiment of the present invention. This diagram is merely an example, which should not unduly limit the scope of the claims recited herein. One of ordinary skill in the art would recognize many variations, modification, and alternatives. As shown, the apparatus 1 introducing charged particles for manufacture of one or more detachable semiconductor films capable of being free-standing for device applications. More specifically, the apparatus 1 includes two systems, system 3 as a charged particle beam generation system and system 5 as a beam application system. System 3 includes the following components: an ion source 10, low energy beam transport unit 15 to capture and guide an initial particle beam 12 at a first energy level, a plurality of modular radio frequency quadrupole or other Linac elements 40, RF power system 20, vacuum system 30, high energy beam transport (HEBT) unit 53 and a beam shaping, mass analysis, and beam scanner and expander 55. The mass analysis and beam scanner can be used to select the appropriate particles for use. Additionally a filtering substrate in unit 55, of appropriate thickness may be used to further minimize unwanted contamination particles. System 5 is a process chamber coupled to the beam expander 55, where the charged particle beam 58 at the second energy level with expanded beam diameter is applied. System 5 further includes a workpiece 70, a tray device 75, a 2-axis moving stage. In addition, both system 3 and 5 are linked to a computer system 90 which provides operation and process controls.

In a specific embodiment, apparatus 1 includes an ion source 10 to generate a plurality of charged particles. The ion source can be generated by electron cyclotron resonance (ECR), microwave generated plasma, inductively coupled plasma, plasma based magnetron ion source, or a penning source or others, depending upon the embodiment. One of ordinary skill in the art would recognize many other variations, modifications, and alternatives. In a preferred embodiment, the plurality of charged particles are collimated as a first beam 12 provided at a first energy level.

Referring again to FIG. 1, first beam 12 at the first energy level is guided by a low energy beam transport (LEBT) unit 15 into a linear accelerator subsystem. The linear accelerator subsystem includes a plurality of modular radio frequency quadrupole (RFQ) elements 40 numbered from 1 through N successively coupled to each other. For example, the LEBT unit is based on a single articulated Einzel lens containing an electrode mounted on a three-axis stage which can be used to guide first beam 12 into an RFQ aperture. The transverse motions are used to guide first beam 12 into RFQ elements 40. A lens voltage and a longitudinal motion can be used to optimize first beam 12 at the first energy level within the plurality of RFQ elements 40. In other embodiments, magnetic confinement, such as by multiple solenoids, also could be employed to provide beam shaping and extraction of charged particles in to the Linac (RF) elements.

In an specific embodiment, the plurality of modular RFQ elements 40 can be used to bunch, focus, and accelerate the first beam of charged particles at the first energy level to a second beam at a second energy level. Particularly, each of the plurality of modular RFQ elements 40 is configured to be a RF resonant cavity in a RF cylindrical structure operating at a resonant frequency of 200 MHz. The RF cylindrical structure can include a quadrupole electrode capable of confining or transversely focusing an high energy charged particles. In one example, the quadrupole electrode is configured to manage the electric field distribution within the cavity. These could be in format of vanes or strut holding configurations. The quadrupole electrode can be configured to manage the distribution of the charged particles within the beam so that the particles are exposed to the electric fields when they are in the accelerating direction and shielded from them when they are in the decelerating direction. The net effect of the RF electric field therein is an acceleration effect for first beam 12. In an alternate embodiment, RFQ elements 40, or specifically, the RFQ elements numbered 2 through N may combine the RF quadrupole with a drift-tube technique, as well as other Linac configurations (RFI, QFI, etc.). The first beam can be accelerated through the plurality of modular RFQ elements 40 to a beam at the second energy level. In a specific embodiment, the second energy level can be in a range of 1 MeV to 5 MeV at an exit aperture on the RFQ element numbered N.

Referring back to FIG. 1, the plurality of modular RFQ elements 40 are powered by a RF power system 20 capable of supplying a continuous wave (CW) output of at least 50 kW and/or a pulsed output of 150 kW at about 30% duty. For example, RF power system 20 may be rated for operation as high as 1000 MHz and have an anode power rating of at least 2.5 kW. There are other embodiments such as use of Triodes, Tetrodes, Klystrodes, Inductively output tube (IOT) or coaxial IOT (C-IOT) to provide such RF power conversions. The RF power system and each of the plurality of modular RFQ elements are coupled to a cooling system (not shown) to prevent the system from overheating. For example, the cooling system may include a plurality of parallel cooling circuits using water or other cooling fluid. In another embodiment, the low energy beam transport unit and each of the plurality of modular RFQ elements are provided in a high vacuum environment 30. For example, a vacuum of less than 5×10⁻⁷ Torr range may be provided using at least one or more 400 liter per second turbomolecular vacuum pumps. Of course there can be other variations, modifications, and alternatives.

As shown in FIG. 1, particle generation system 3 further includes a high energy beam transport (HEBT) unit 53 at the exit aperture of the RFQ element numbered N to capture and guide the beam into a beam expander 55. For example, the beam expander can use a magnetic field managed through a plurality of magnets in quadrupoles, sextupoles, octupoles and/or higher multipoles configuration to uniformly re-distribute a charged particle beam to one with a larger diameter. The beam expansion can also occur through drift of the beam over a distance, where the beam will naturally expand to the desired beam diameter and beam flux spatial distribution. Using the beam expander, the charged particle beam 58 at the second energy level can have a beam diameter up to 500 mm on a substrate. The expanded beam diameter reduces a power flux of high energy particles to prevent overheating of the substrate. The expanded beam also prevents face damage of the substrate. Additionally, an optimized dose rate of an ion into a substrate can be provided by at least beam diameter adjustment and beam current control. For example, the total current of the expanded charged ion beam can be up to 20 mA. With a 500 mm beam diameter the power flux can be controlled to under 50 W/cm², as the power flux is low enough that slow scanning (or even no scanning) of the expanded beam can occur without surface overheating. For example, with a smaller beam diameter such as 5 cm (useful for generating patterned implant dose profiles within each tile), the power flux can be as high as 5-10 kw/cm² and require magnetic or electrostatic fast scanning to avoid surface overheating. In another embodiment, the output port of the beam expander is directly coupled to the beam application system where the expanded beam of charged particles can be used for implantation into, for example, into a semiconductor substrate. The implanted semiconductor substrate may be further processed to form one or more free standing thick film to be used in application such photovoltaic cell. Furthermore, the HEBT could contain elements for magnetic or electrical mass analysis, to provide the required species only into the substrate. This will allow for some beam shaping as well changing the direction of the beam to improve the packaging of the total system.

In one embodiment, system 5, which is operably coupled to the beam expander, can be a process chamber capable of receiving the high energy beam of charged particles. In a specific embodiment, the high energy beam of charged particles may be provided at MeV level using the expanded beam. For example, workpiece 70, which can be one or more tile-shaped semiconductor materials, can be mounted on a tray device 75 and be exposed to the high energy beam of charged particles. In a specific embodiment, in such that the workpiece can be arranged substantially perpendicular to the direction of the high energy beam of charged particles. In another embodiment, the tray device may includes a two-axis stage 80 through which the tray device 75 is capable of moving 2-dimensionally thereby allowing the high energy beam of charged particles to scan across the entire surface of the workpiece. In another embodiment, movement of the workpieces in a third dimension may also be employed to improve system performance. Of course there can be other variations, modifications, and alternatives.

Referring again to FIG. 1, a control system 90 is coupled to the apparatus. The control system can be a computer system. The control system provides operation and processing controls respectively for both system 3 and system 5. For system 3, ion source 10 can be adjusted to provide a collimated charge particle beam with a desired current, for example, up to 30 mA. The RF power system 20 can be operated in continuous wave (CW) mode or pulsed mode. The control system controls the RF power, including desired power level and matching frequency delivered into the linear accelerator, which is formed by the plurality of modular RFQ elements. For example, the RFQ elements can include RF quadrupole unit, drift tube, or a combination in CW mode. In CW mode, the total RF power dissipation in the RF quadrupole unit (or the RFQ element numbered 1) can be at least 40 kW and the total RF power dissipation into the rest of RFQ elements (i.e., RFQ elements numbered from 2 to N) is at least 26 kW. The beam transport units are also controlled by the control system by adjusting the three-axis moving stage and lens voltage to provide an optimized beam capture. The control system is linked to the beam expander to a desired beam diameter and beam uniformity of an output beam. In a specific embodiment, the beam expander is controlled using a magnetic field. In an alternative embodiment, the control system 90 is coupled to the beam application system to provide processing control such as temperature measurement and workpiece control within the tray device. Of course there can be other variations, modifications, and alternatives.

In a specific embodiment, the present method uses a mass-selected high-energy implant approach, which has the appropriate beam intensity. To be cost-effective, the implant beam current should be on the order of a few tens of milliamps of H⁺ or H⁻ ion beam current. If the system can implant such sufficiently high energies, H₂⁺ ions can also be advantageously utilized for achieving higher dose rates. Such ion implant apparatuses have been made recently available by the use of radio-frequency quadrupole linear accelerator (RFQ Linac), Drift-Tube Linac (DTL), RF (Radio)-Focused Interdigitated (RFI), or Quadrupole Focused Interdigitated (QFI) technology, as may be available from companies such as Accsys Technology Inc. of Pleasanton, Calif., Linac Systems, LLC of Albuquerque, N. Mex. 87109, and others.

In a specific embodiment, the apparatus according to embodiments of the present invention provides a charged particle beam at MeV energy level to provide for an implantation process. The implantation process introduces a plurality of impurity particles to a selected depth within a thickness of a semiconductor substrate to define a cleave region within the thickness. Depending upon the application, smaller mass particles are generally selected to reduce a possibility of damage to the material region according to a preferred embodiment. That is, smaller mass particles easily travel through the substrate material to the selected depth without substantially damaging the material region that the particles traverse through. For example, the smaller mass particles (or energetic particles) can be almost any charged (e.g., positive or negative) and or neutral atoms or molecules, or electrons, or the like. In a specific embodiment, the particles can be charged particles including ions such as ions of hydrogen and its isotopes, rare gas ions such as helium and its isotopes, and neon, or others depending upon the embodiment. The particles can also be derived from compounds such as gases, e.g., hydrogen gas, water vapor, methane, and hydrogen compounds, and other light atomic mass particles. Alternatively, the particles can be any combination of the above particles, and or ions and or molecular species and or atomic species. The particles generally have sufficient kinetic energy to penetrate through the surface to the selected depth underneath the surface.

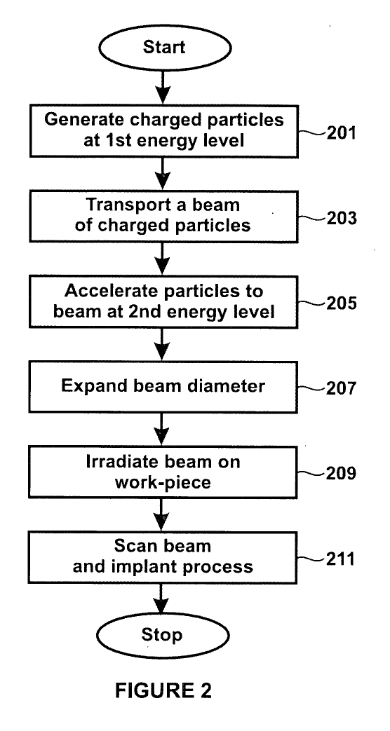

Referring now to the FIG. 2, which is a simplified diagram of a method to generate high energy charged particles according to an embodiment of the present invention. As show, the method includes a step of generating a plurality of charged particles at a first energy level (Step 201). In a specific embodiment, the plurality of charged particles at the first energy may be provided using an ion source such as electron cyclotron resonance (ECR), inductively coupled plasma, plasma based magnetron ion source, or a penning source. The plurality of charged particles at a first energy level is guided in a low energy transport (LEBT) unit (Step 203) into a liner accelerator. The liner accelerator accelerate the plurality of charged particles at a first energy level (Step 205) to produce a plurality of charged particles at a second energy level. The second energy level is greater than the first energy level. The plurality of charged particles at the second energy level is subjected to a beam expander (Step 207) to expand a beam diameter of the plurality of charged particles at the second energy level. The method irradiates the expanded beam onto a workpiece (Step 209). In a specific embodiment, the workpiece can be semiconductor substrates tiles provided in a tray device. The expanded beam of the plurality of charged particles is scanned (Step 211) and provide an implantation process for, for example, forming a substrate for photovoltaic application. Of course on skilled in the art would recognize many variations, modifications, and alternatives, where one or more steps may be added, one or more steps may be eliminated, or the steps may be provided in a different sequence.

Using hydrogen as the implanted species into the silicon wafer as an example, the implantation process is performed using a specific set of conditions. Implantation dose ranges from about 1×10¹⁵ to about 1×10¹⁶ atoms/cm², and preferably the dose is less than about 5×10¹⁶ atoms/cm². Implantation energy ranges from about 1 MeV and greater to about 5 MeV and greater for the formation of thick films useful for photovoltaic applications. Implantation temperature ranges from about −50 to about 550 Degrees Celsius, and is preferably less than about 400 Degrees Celsius to prevent a possibility of hydrogen ions from diffusing out of the implanted silicon wafer. The hydrogen ions can be selectively introduced into the silicon wafer to the selected depth at an accuracy of about ±0.03 to ±1.5 microns. Of course, the type of ion used and process conditions depend upon the application.

As an example, MeV range implant conditions have been disclosed by Reutov et al. (V. F. Reutov and Sh. Sh. Ibragimov, “Method for Fabricating Thin Silicon Wafers”, USSR's Inventors Certificate No. 1282757, Dec. 30, 1983), which is hereby incorporated by reference. In V. G. Reutov and Sh. Sh. Ibragimov, the use of up to 7 MeV proton implantation with optional heating during implant and post-implant reusable substrate heating was disclosed to yield detached silicon wafer thicknesses up to 350 um. A thermal cleaving of a 16 micron silicon film using a 1 MeV hydrogen implantation was also disclosed by M. K. Weldon & al., “On the Mechanism of Hydrogen-Induced Exfoliation of Silicon”, J. Vac. Sci. Technol., B 15(4), July/August 1997, which is hereby incorporated by reference. The terms “detached” or “transferred silicon thickness” in this context mean that the silicon film thickness formed by the implanted ion range can be released to a free standing state or released to a permanent substrate or a temporary substrate for eventual use as a free standing substrate, or eventually mounted onto a permanent substrate. In a preferred embodiment, the silicon material is sufficiently thick and is free from a handle substrate, which acts as a supporting member. Of course, the particular process for handling and processing of the film will depend on the specific process and application.

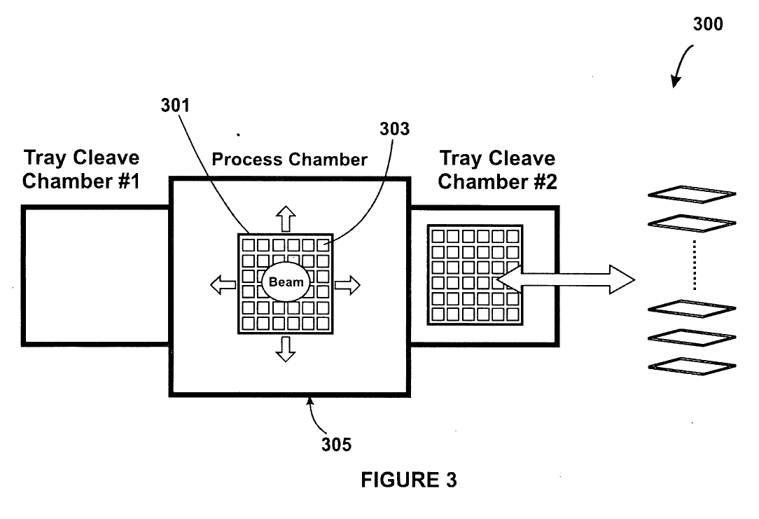

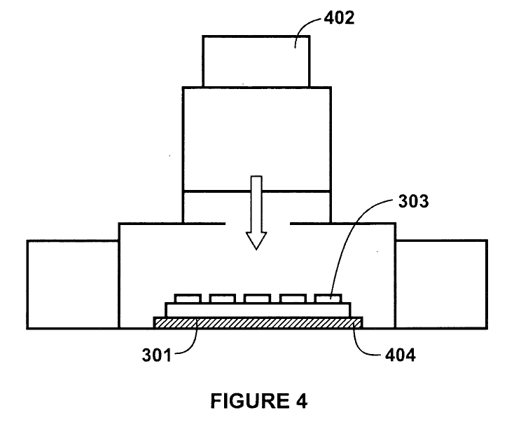

FIG. 3 is a simplified diagram illustrating a system 300 for forming substrates using a continuous process according to an embodiment of the present invention. This diagram is merely an example and should not unduly limit the scope of the claims herein. One of ordinary skill in the art would recognize other variations, modifications, and alternatives. As shown in FIG. 3, the system includes providing at least one substrate members 301. Each of the substrate members includes a plurality of tiles 303 disposed thereon. Each of the plurality of sites includes a reusable substrate member 303 to be implanted. In a specific embodiment, each of the plurality of tiles may include semiconductor substrate such as single crystal silicon wafers, polysilicon cast wafer, tile, or substrate, silicon germanium wafer, germanium wafer, group III/V materials, group II/VI materials gallium nitride or the like. Any of the single-crystal material can be cut to specific orientations that offer advantages such as ease of cleaving, preferred device operation or the like. For example, silicon solar cells can be cut to have predominantly (100), (110), or (111) surface orientation to yield a free-standing substrate of this type. Of course, starting material having orientation faces which are intentionally miscut from the major crystal orientation, can be also prepared. The system also includes an implant device (not shown). The implant device is housed in a process chamber 305. In a specific embodiment, the implant device provides a scanning implant process. Such implanting device can use an expanded high energy ion beam generated in a linear accelerator in a specific embodiment. As shown in FIG. 4, the implanting device includes an ion implant head 402 to provide for impurities to be implanted in the plurality of tiles. The system also includes a movable track member 404. The movable track member can include rollers, air bearing, or a movable track in certain embodiments. Movable track member 404 provides a spatial movement of the substrate member for the scanning implant process. Of course there can be other variations, modifications, and alternatives.

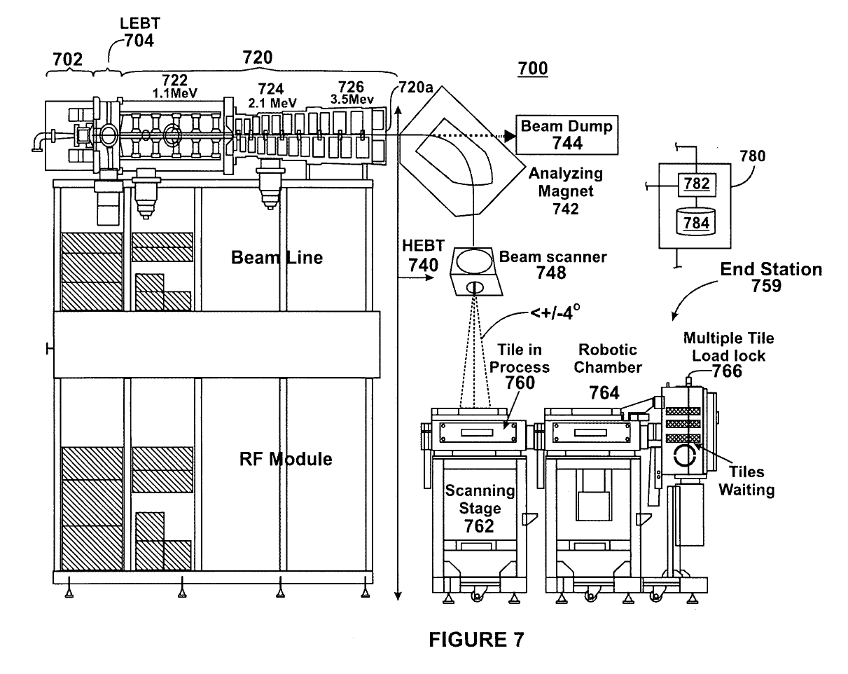

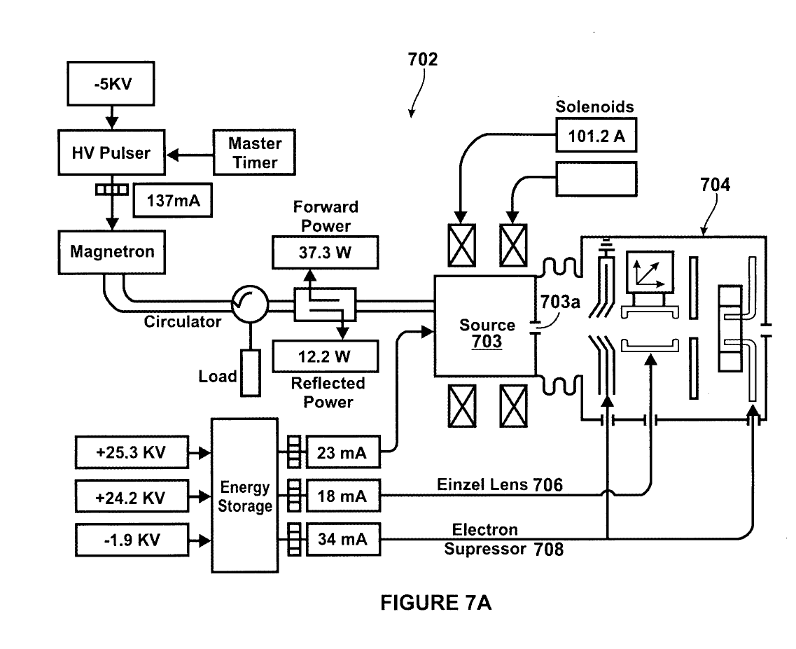

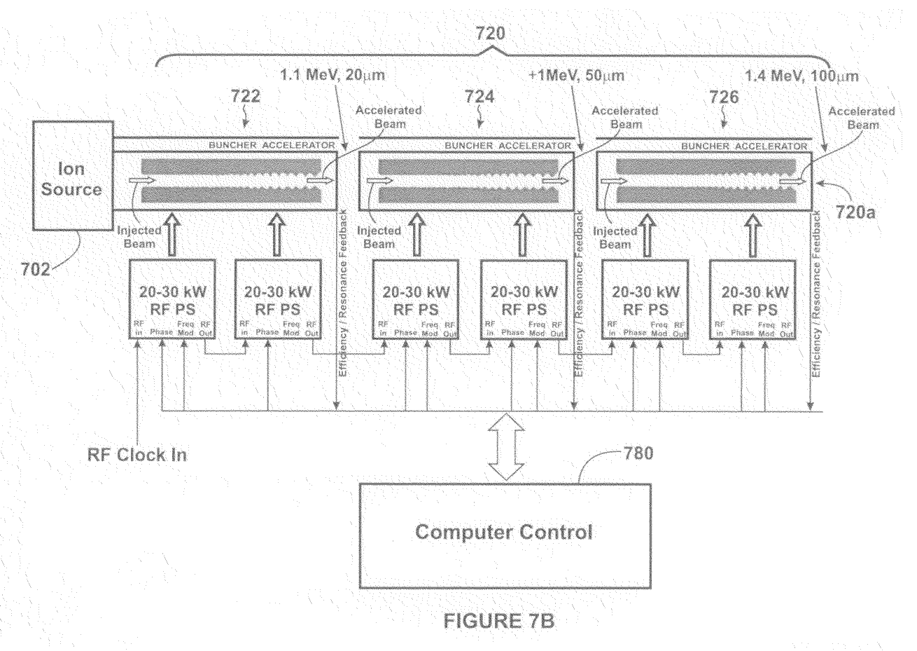

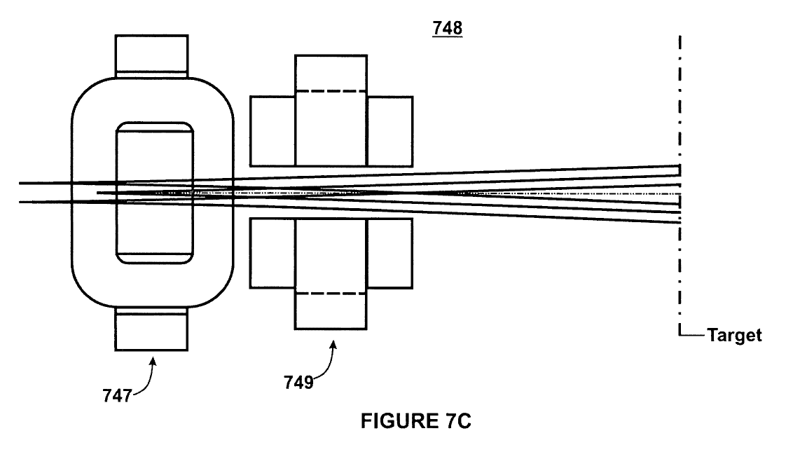

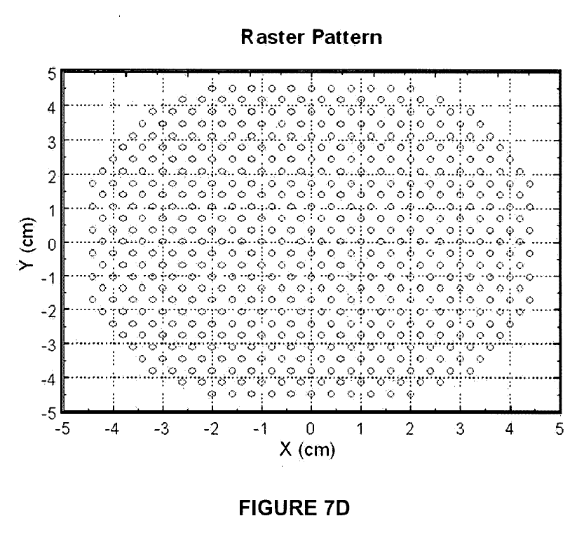

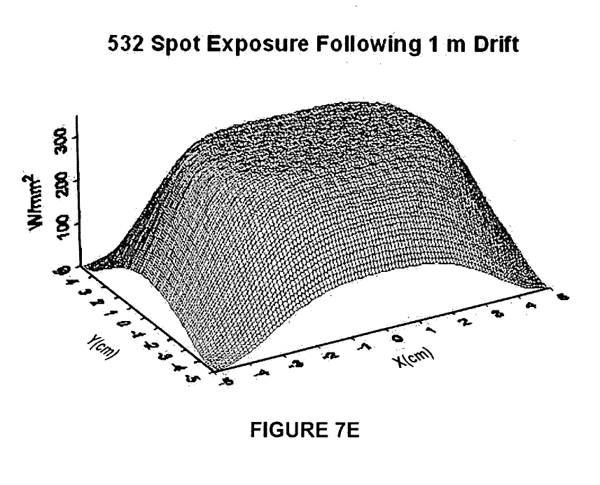

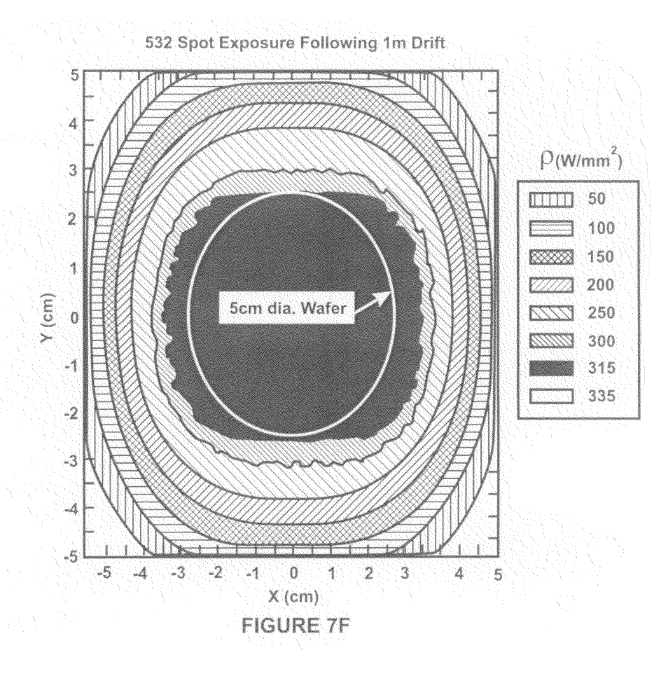

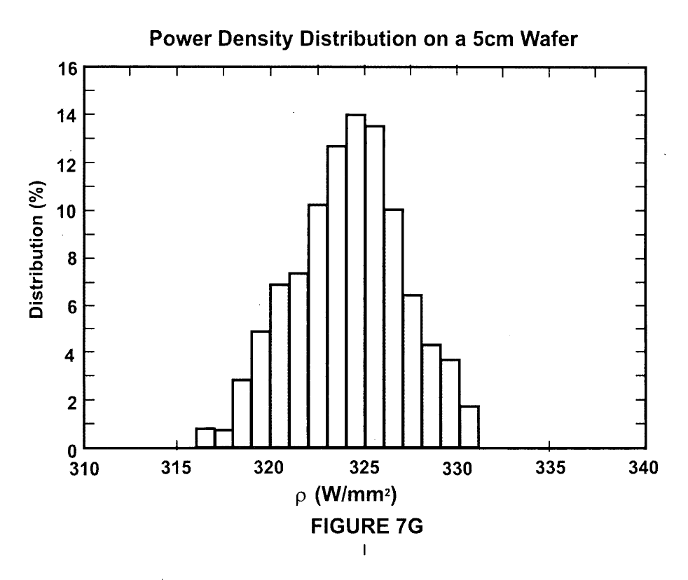

Certain embodiments in accordance with the present invention may employ a scanning mode for implantation. An example of such an embodiment is shown in the simplified schematic views of FIGS. 7-7C. In particular, FIG. 7 is a simplified schematic diagram illustrating components of an embodiment of an apparatus for performing implantation according to the present invention. FIG. 7A shows an enlarged schematic view of the ion source and low energy beam transport section of the apparatus of FIG. 7.

Apparatus 700 comprises ion source 702 in vacuum communication with Low Energy Beam Transport (LEBT) section 704. LEBT section 704 can contain electrical and or magnetic beam extraction, shaping and focusing. The LEBT section 704 performs at least the following functions.

Referring to FIG. 7A, the LEBT takes the ions that stream out of the aperture 703a in the ion source chamber 703, and accelerates these ions to a relatively low energy (100 keV or less, and here ˜30 keV). This acceleration of the ions achieves the resonance velocity necessary to couple to the first, Radio Frequency Quadrupole (RFQ) stage 722 of the succeeding linear accelerator (linac) section 720. Alternatively, this can be achieved through the use of multiple solenoids that magnetically can extract, shape, and focus the beam.

Examples of ion sources include ECR, microwave ion sources, magnetron ion sources, and Penning sources. Examples of ionization methods include the use of e-beams, lasers, cold and hot cathode discharges, and thermal techniques.

The LEBT 704 also typically functions to shape the ion beam for optimum acceptance into the first, RFP stage 722 of the linac section 720. In this particular embodiment, the beam shaping element is an Einzel lens 706. However, in alternative embodiments other LEBT lenses using different designs such as solenoid (magnetic field lensing), can be used.

The LEBT 704 also include an electron suppressor element 708. This element 708 serves to suppress secondary electrons generated by errant ions interacting with exposed surfaces of the LEBT.

Upon entry into the linac section 720, the ion beam is accelerated to higher and higher energies by successive stages. FIG. 7B shows a simplified schematic view of the linear accelerator section 720.

In the first, RFQ stage 722, the ions are accelerated from the energy of ˜30 keV, to an energy of about 1.1 MeV. In a second linac stage 724, the ions are accelerated to about 2.1 MeV. In the third and final linac stage 726, the ions are accelerated to energies of about 3.5 MeV or even greater.

The ion beam presented by the LEBT to the entrance of the first accelerator 722 is continuous during the source pulse. However, via the alternating acceleration/focusing mechanisms of the RF accelerators 720, this continuous beam is transformed into packets or bunches temporally spaced one RF period apart as they are accelerated down these linacs. FIG. 7B shows the typical level RF amplifier, feedback controls, and RF connections to the linacs. One or multiple RF inputs couple to one or more combinations of RFQ and RFI, linacs. During operation, the reflected powers from the RFQ and RFI cavities are monitored. In the closed feedback loop. the RF frequency is adjusted to minimize the reflected power by maintaining resonances simultaneously in all the cavities.

The combination of RFQ and RFI may be chosen to maximize the efficiency of the system. Since the efficiency of the RFQ technology decreases with proton energies above ˜0.75 MeV, the RFI linac (which is more efficient than a RFQ linac) may be used in subsequent acceleration stages to achieve the final beam energies.

Upon passing through an exit aperture 720a in the linac section 720, the ion beam enters the High Energy Beam Transport (HEBT) section 740. The function of the HEBT section 740 is to shape the highly energetic ion beam exiting from the final linac stage 726 (e.g. from elliptical to circular), to bend the path of the highly energetic ion beam, and, if appropriate, to achieve scanning of the beam on the target. The beam shaping and focusing is carried out using various combinations of quadrupole and Sextupole etc. magnetic focusing, where the magnetic field is arranged is a manner to shape the beam in the preferred direction. The beam travels through a set of diagnostic elements and enters a dipole magnet for mass analysis. At this point, the magnetic field is arranged so that the momentum of the charged particles will be analyzed.

Specifically, the highly energized ion beam is first optionally exposed to analyzing magnet 742, which alters the direction of the beam and performs the cleansing function described throughout the instant application, such that initial contaminants of the high energy beam are routed to beam dump 744.

In accordance with certain embodiments, the analyzing magnet 742 exerts a force over the beam that is consistent over time, such that the resulting direction of the of the cleansed beam does not vary. In accordance with alternative embodiments, however, the analyzing magnet may exert a force over the beam that does change over time, such that the direction of the beam does in fact vary. As described in detail below, such a change in beam direction accomplished by the analyzing magnet, may serve to accomplish the desired scanning of the beam along one axis.

After this analyzing magnet element, further focusing of the beam may occur, and finally the beam will be scanned using various methods to both provide a DC off set and or AC varying beam. There can be sophisticated control systems for scribing whole area coverage, or patterned coverage (i.e. lines or spots only).

Specifically, upon exiting the analyzing magnet, the cleansed ion beam enters beam scanner 748. FIG. 7C shows a simplified schematic diagram of one embodiment of the beam scanner 748 in accordance with the present invention. Specifically, beam scanner 748 comprises a first scanner dipole 747 configured to scan to vary the location of the beam in a first plane. Beam scanner 748 also comprises a second scanner dipole 749 configured to scan to vary the location of the beam in a second plane perpendicular to the first plane.

Throughout the HEBT, the beam is allowed to expand by allowing a dedicated drift portion. A beam expander may be the final element in the HEBT. The beam expander can be a device (magnetic octupole or the like), or can be a length of travel for the beam that allows it to expand on its own. Beam expansion due to additional travel may be preferred, as use of the scanner could render active expanding/shaping the beam downstream of the scanner, extremely difficult. In summary, the beam is transported from the Linac, to a beam analyzer, then to a beam scanner, and lastly undergoes beam expansion.

FIGS. 7D-G show simulated results of scanning an high energy beam of ions over a workpiece according to an embodiment of the present invention. Specifically, FIG. 7D shows a raster pattern of 532 spot exposure. FIG. 7E plots in three dimensions the power density of the 532 spot exposure of FIG. 7D. FIG. 7E plots in two dimensions the power density of the 532 spot exposure of FIG. 7D.

FIG. 7G is a bar graph of the power density versus distribution on a 5 cm wafer. the following 1 m drift. Taken together, these figures indicate that it is possible to irradiate a 5 cm diameter workpiece with a proton density of 3E16/sq-cm with a power density uniformity of less than <5%.

While the particular embodiment of the beam scanner shown in FIG. 7C includes two dipoles, this is not required by the present invention. In accordance with alternative embodiments, the beam scanner could include only a single dipole. Specifically, in accordance with certain embodiments, the analyzer magnet located upstream of the beam scanner, could be utilized to provide scanning in a plane perpendicular to that in which scanning is achieved by a single dipole of the beam scanner. In one such embodiment, time-variance in the magnetic field of the analyzer magnet may result in an energized beam whose direction varies by +/−4° from the normal. Such “wobble” in the direction of the cleansed beam exiting the analyzing magnet, may be utilized for scanning in place of a second dipole of the beam scanner. Alternatively, such a wobbled beam may be used in conjunction with a beam scanner also having a second dipole, such that magnitude of scanning in the direction of the wobble is increased. Such beam scanners can be used to move the beam by a DC shift, and then allow the wobbling to occur.

Throughout the HEBT, the beam is allowed to expand by allowing a dedicated drift portion. A beam expander is the final element in the HEBT. The beam expander can be a device (magnetic octupole or the like), or can be a length of travel for the beam that allows it to expand on its own. Beam expansion due to additional travel may be preferred, as use of the beam scanner would render difficult downstream approaches to beam expansion. In summary, the beam is transported from the Linac, to a beam analyzer, then to a beam scanner, and lastly undergoes beam expansion.

While the particular embodiment shown in FIG. 7 includes elements for shaping and controlling the path of the beam, these are not required by the present invention. Alternative embodiments in accordance with the present invention could employ a drift tube configuration, lacking such elements and allowing the shape of the beam to expand after it exits the accelerator.

FIG. 7 shows the remaining components of the apparatus, including an end station 759. In this end station 759, tiles 760 in the process of being scanned with the energetic ion beam, are supported in a vacuum in scanning stage 762. The tiles 760 are provided to the scanning stage through a robotic chamber 764 and a load lock 766.

The scanning stage 762 may function to translate the position of the workpieces or bulk materials receiving the particle beam. In accordance with certain embodiments, the scanning stage may be configured to move along a single axis only. In accordance with still other embodiments, the scanning stage may be configured to move along two axes. As shown in the particular embodiment of FIG. 7, physical translation of the target material by the scanning stage may be accompanied by scanning of the beam by the scanning device acting alone, or in combination with scanning accomplished by the beam filter. A scanning stage is not required by the present invention, and in certain embodiments the workpieces may be supported in a stationary manner while being exposed to the radiation.

The various components of the apparatus of FIGS. 7-7C are typically under the control of a host computer 780 including a processor 782 and a computer readable storage medium 784. Specifically, the processor is configured to be in electronic communication with the different elements of the apparatus 700, including the ion source, accelerator, LEBT, HEBT, and end station. The computer readable storage medium has stored thereon codes for instructing the operation of any of these various components. Examples of aspects of the process that may be controlled by instructions received from a processor include, but are not limited to, pressures within the various components such as end station and the HEBT, beam current, beam shape, scan patterns (either by scanning the beam utilizing a scanner and/or analyzing magnet, and/or moving the target utilizing translation with XY motored stages at substrate, i.e. painting), beam timing, the feeding of tiles into/out of the end station, operation of the beam cleaning apparatus (i.e. the analyzing magnet), and flows of gases and/or power applied to the ion source, etc.

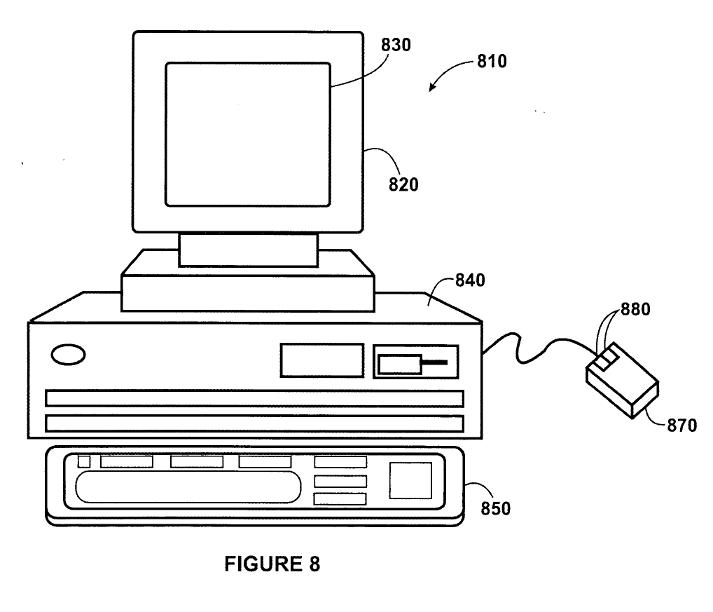

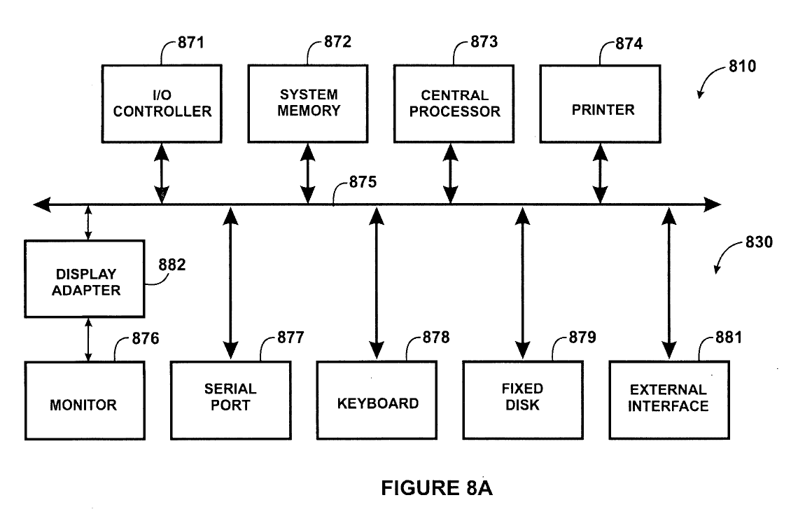

The various components of the coupon system described above may be implemented with a computer system having various features. FIG. 8 shows an example of a generic computer system 810 including display device 820, display screen 830, cabinet 840, keyboard 850, and mouse 870. Mouse 870 and keyboard 850 are representative “user input devices.” Mouse 870 includes buttons 880 for selection of buttons on a graphical user interface device. Other examples of user input devices are a touch screen, light pen, track ball, data glove, microphone, and so forth. FIG. 8 is representative of but one type of system for embodying the present invention. It will be readily apparent to one of ordinary skill in the art that many system types and configurations are suitable for use in conjunction with the present invention. In a preferred embodiment, computer system 810 includes a Pentium class based computer, running Windows NT operating system by Microsoft Corporation. However, the apparatus is easily adapted to other operating systems and architectures by those of ordinary skill in the art without departing from the scope of the present invention.

As noted, mouse 870 can have one or more buttons such as buttons 880. Cabinet 840 houses familiar computer components such as disk drives, a processor, storage device, etc. Storage devices include, but are not limited to, disk drives, magnetic tape, solid state memory, bubble memory, etc. Cabinet 840 can include additional hardware such as input/output (I/O) interface cards for connecting computer system 810 to external devices external storage, other computers or additional peripherals, further described below.

FIG. 8A is an illustration of basic subsystems in computer system 810 of FIG. 8. This diagram is merely an illustration and should not limit the scope of the claims herein. One of ordinary skill in the art will recognize other variations, modifications, and alternatives. In certain embodiments, the subsystems are interconnected via a system bus 875. Additional subsystems such as a printer 874, keyboard 878, fixed disk 879, monitor 876, which is coupled to display adapter 882, and others are shown. Peripherals and input/output (I/O) devices, which couple to I/O controller 871, can be connected to the computer system by any number of means known in the art, such as serial port 877. For example, serial port 877 can be used to connect the computer system to a modem 881, which in turn connects to a wide area network such as the Internet, a mouse input device, or a scanner. The interconnection via system bus allows central processor 873 to communicate with each subsystem and to control the execution of instructions from system memory 872 or the fixed disk 879, as well as the exchange of information between subsystems. Other arrangements of subsystems and interconnections are readily achievable by those of ordinary skill in the art. System memory, and the fixed disk are examples of tangible media for storage of computer programs, other types of tangible media include floppy disks, removable hard disks, optical storage media such as CD-ROMS and bar codes, and semiconductor memories such as flash memory, read-only-memories (ROM), and battery backed memory.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

Effectively, the implanted particles add stress or reduce fracture energy along a plane parallel to the top surface of the substrate at the selected depth. The energies depend, in part, upon the implantation species and conditions. These particles reduce a fracture energy level of the substrate at the selected depth. This allows for a controlled cleave along the implanted plane at the selected depth.

According to particular embodiments, implantation can occur under conditions such that the energy state of the substrate at all internal locations is insufficient to initiate a non-reversible fracture (i.e., separation or cleaving) in the substrate material. Alternatively, a patterned implant can be employed to introduce particles into only certain areas of the substrate, or to introduce lower doses in certain areas.

According to certain such embodiments, patterned implantation can be employed such that only regions in which cleaving is to be initiated, receive a full or high dose. Other regions where cleaving is merely to be propagated, may received reduced doses or no doses at all. Such variation in dosage may be accomplished either by controlling the dwell time of the beam in a particular region, by controlling the number of times a particular region is exposed to the beam, or by some combination of these two approaches. In one embodiment, a beam of 20 mA of H+ ions may provide a flux of 1.25×10¹⁷H atom/(cm² sec), with a minimum dwell time of 200 μs, resulting from a scan speed of 2.5 km/sec (corresponding to a scan frequency of 1.25 KHz within a 1 meter tray width using a 5 cm beam diameter), resulting in a per-pass minimum dose of 2.5×10¹³H atom/cm². Longer dwell times, of course, would increase the dosage received.

According to certain embodiments, cleaving action in high dose regions may be initiated by other forces, including but not limited to physical striking (blades), ultrasonics, or the stress resulting from the differences in coefficients of thermal expansion/contraction between different materials. In accordance with one particular embodiment, the substrate may be bonded to a metal layer, which as the substrate/metal combination cools, induces a stress sufficient to initiate cleaving in the regions receiving a high implant dosage, and/or propagate a pre-existing implant initiation region.

It should be noted, however, that implantation does generally cause a certain amount of defects (e.g., micro-detects) in the substrate that can typically at least partially be repaired by subsequent heat treatment, e.g., thermal annealing or rapid thermal annealing. Optionally, the method includes a thermal treatment process after the implanting process according to a specific embodiment. In a specific embodiment, the present method uses a thermal process ranging from about 450 to about 600 Degrees Celsius for silicon material. In a preferred embodiment, the thermal treatment can occur using conduction, convection, radiation, or any combination of these techniques. The high-energy particle beam may also provide part of the thermal energy and in combination with a external temperature source to achieve the desired implant temperature. In certain embodiment, the high-energy particle beam alone may provide the entire thermal energy desired for implant. In a preferred embodiment, the treatment process occurs to season the cleave region for a subsequent cleave process. Of course, there can be other variations, modifications, and alternatives.

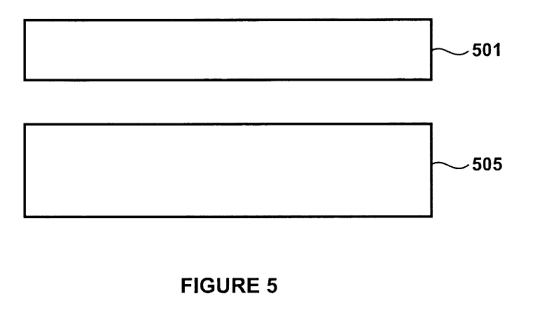

In a specific embodiment, the method includes a step of freeing the thickness of detachable material, which is free standing, using a cleaving process, while the detachable material is free from an overlying support member or the like, as illustrated by FIG. 5. As shown, the detachable material 501 is removed from the remaining substrate portion 505. In a specific embodiment, the step of freeing can be performed using a controlled cleaving process. The controlled cleaving process provides a selected energy within a portion of the cleave region of the donor substrate. As merely an example, the controlled cleaving process has been described in U.S. Pat. No. 6,013,563 titled Controlled Cleaving Process, commonly assigned to Silicon Genesis Corporation of San Jose, Calif., and hereby incorporated by reference for all purposes. As shown, the method frees the thickness of material from the substrate to completely remove the thickness of material. Of course, there can be other variations, alternatives, and modifications.

In one embodiment, the method uses one or more patterned regions to facilitate initiation of a cleaving action. In a specific embodiment, the present method provides a semiconductor substrate having a surface region and a thickness. The method includes subjecting the surface region of the semiconductor substrate to a first plurality of high energy particles generated using a linear accelerator to form a patterned region of a plurality of gettering sites within a cleave region. In a preferred embodiment, the cleave region is provided beneath the surface region to defined a thickness of material to be detached. The semiconductor substrate is maintained at a first temperature. The method also includes subjecting the semiconductor substrate to a treatment process, e.g., thermal treatment. The method includes subjecting the surface region of the semiconductor substrate to a second plurality of high energy particles, which have been provided to increase a stress level of the cleave region from a first stress level to a second stress level. The method includes initiating the cleaving action at a selected region of the patterned region to detach a portion of the thickness of detachable material using a cleaving process and freeing the thickness of detachable material using a cleaving process.

A patterned implant sequence may subject the surface to variation in dose where the initiation area is usually developed, using a higher dose and/or thermal budget sequence. Propagation of the cleaving to complete the cleaving action can occur in a number of ways. One approach uses additional dosed regions to guide the propagating cleave front. Another approach to cleaving propagation follows a depth that is guided using stress-control. Still another cleaving propagation approach follows a natural crystallographic cleave plane.

Some or most of the area may be implanted at a lesser dose, or not implanted at all, depending on the particular cleaving technique used. Such lower dosed regions can help improve overall productivity of the implantation system, by reducing the total dose needed to detach each film from the substrate.

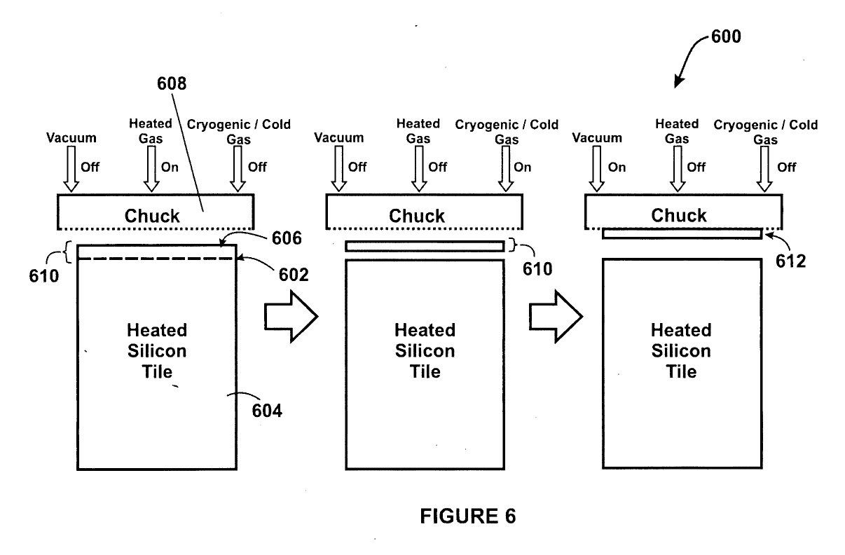

FIG. 6 illustrates a method 600 of freeing a thickness of detachable material 610 according to an alternative embodiment of the present invention. As shown, a cleave plane 602 is provided in a substrate 604 having a surface region 606. The substrate can be a silicon wafer or the like. The cleave plane can be provided using implanted hydrogen species described elsewhere in the present specification in a specific embodiment. Other implant species may also be used. These other implant species can include helium species or a combination. In a specific embodiment, the substrate is maintained at a pre-determined temperature range. As shown, a chuck member 608 is provided. The chuck member includes means to provide a vacuum, a heated gas, and a cryogenic/cold gas. To detach the detachable material, the chuck member is coupled to the surface region of the substrate and the chuck member release a heated gas to increase the temperature of the substrate to another range. The substrate is cooled using the cryogenic/cold gas to cause detachment of the thickness of material from the substrate. The detached thickness of material may then be removed by applying a vacuum to the surface region 612. Of course there can be other variations, modifications, and alternatives.

In a specific embodiment, the present method can perform other processes. For example, the method can place the thickness of detached material on a support member, which is later processed. Additionally or optionally, the method performs one or more processes on the semiconductor substrate before subjecting the surface region with the first plurality of high energy particles. Depending upon the embodiment, the processes can be for the formation of photovoltaic cells, integrated circuits, optical devices, any combination of these, and the like. Of course, there can be other variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An apparatus for providing charged particles for manufacture of one or more detachable semiconductor films capable of being free-standing, the apparatus comprising:
an ion source to generate a plurality of charged particles, the plurality of charged particles being provided as a collimated beam at a first energy level;
an radio frequency quadrupole (RFQ) linear accelerator, the RFQ linear accelerator comprising a plurality of modular radio frequency quadrupole (RFQ) elements numbered from 1 through N, where N is an integer greater than 1, each of the plurality of modular RFQ elements being coupled successively to each other, the RFQ linear accelerator controls and accelerates the beam of charged particles at the first energy level into a beam of charge particles having a second energy level, RFQ element numbered 1 being operably coupled to the ion source;
an exit aperture coupled to RFQ element numbered N of the RFQ linear accelerator;
a beam expander coupled to the exit aperture, the beam expander being configured to process the beam of charged particles at the second energy level into an expanded beam of charged particles;
a process chamber coupled to the beam expander; and
a workpiece provided within the process chamber, the workpiece including a surface region being implanted by the expanded beam of charged particles.

2. The apparatus of claim 1 wherein the ion source is selected from an ECR ion source, a microwave ion source, an ICP ion source, or others.

3. The apparatus of claim 1 wherein the plurality of charged particles generated by the ion source can be selected from H⁻ or H⁺ (proton) or H²⁺ species.

4. The apparatus of claim 1 wherein the ion source is capable of generating an ion beam with an adjustable current up to 30 mA at an energy of about 25 keV.

5. The apparatus of claim 1 wherein the ion source is capable of operating in a continuous mode or a pulsed mode with pulse lengths adjustable from 10 to 100 μs and repetition rates adjustable from 10 to 3000 Hz.

6. The apparatus of claim 1 wherein the RFQ element numbered 1 comprises a RFQ linac subsystem with a resonant frequency of about 200 MHz capable of focusing, bunching, and accelerating an ion beam from an energy of 25 keV to an energy of at least 0.75 MeV.

7. The apparatus of claim 1 wherein the accelerated beam exiting the RFQ element numbered N may be a proton beam with a current up to about 30 mA at an energy level ranging from 0.5 to 7 MeV.

8. The apparatus of claim 1 wherein the beam expander is capable of processing the beam with a beam size adjustable from 3 mm or less to about 50 cm using magnetic quadrupole and/or octupole fields.

9. The apparatus of claim 1 wherein the process chamber comprises a tray device to support the workpiece such that at least part of the surface region is irradiated with the beam of charged particles at the second energy level.

10. The apparatus of claim 9 wherein the tray device is configured to move to allow the beam of charged particles to scan across the surface region and to be implanted into the workpiece.

11. The apparatus of claim 1 further comprises a computer control system configured to control the ion source beam current, rf power supply, beam dynamics, implantation and/or cleavage process.

12. A method for introducing charged particles for manufacture of one or more detachable semiconductor films capable of being free-standing for device applications, the method comprising:
generating a beam of charged particles with a beam current at a first energy level using an ion source;
transferring the beam at a first energy level to a beam at a second energy level through a radio frequency quadrupole (RFQ) linear accelerator coupled to the ion source, the RFQ linear accelerator comprising a plurality of modular RFQ elements numbered 1 to N, where N is an integer greater than 1;
processing the beam at the second energy level with a beam expander coupled to the RFQ linear accelerator to expand the beam size capable of implanting the charges particles; and
irradiating the beam at the second energy level into a workpiece through a surface region, the workpiece being mounted in a process chamber coupled to the beam expander in such a way that the beam at the second energy level with a certain beam size can scan across the surface region and create a cleave region with an averaged implantation dose at a depth of greater than about 50 microns from the surface region of the workpiece.

13. The method of claim 12 wherein the second energy level is between about 0.5 and 7 MeV.

14. The method of claim 12 wherein the beam of charged particles comprises hydrogen ions.

15. The method of claim 12 wherein irradiating the beam comprises changing a position of the beam on the workpiece by scanning the beam or translating the workpiece.

16. A system comprising:
an ion source configured to output a low energy ion beam;
a low energy beam transport (LEBT) section configured to focus the low energy ion beam received from the ion source;
a linear accelerator configured to convert the focused low energy ion beam into a high energy ion beam;
a high energy beam transport (HEBT) section configured to receive the high energy ion beam; and
an end station configured to support a bulk material such that a surface of the bulk material is exposed to the high energy ion beam.

17. The system of claim 16 wherein:
the ion source comprises an electron cyclotron resonance (ECR) or microwave source of the beam comprising hydrogen ions;
the LEBT section comprises an Einzel lens or a solenoid lens;
the linear accelerator comprises a series of successive radio frequency quadrupole (RFQ) stages configured to accelerate the beam of hydrogen ions to an energy of between about 0.5-7 MeV;
the HEBT section comprises a scanning device; and
the end station is configured to support a plurality of bulk materials on a common tray.

18. The system of claim 16 wherein the HEBT section comprises a device configured to scan the beam across one of the plurality of bulk materials.

19. The system of claim 18 wherein the scanning device comprises electrostatic or magnetic elements.

20. The system of claim 18 wherein the scanning device is configured to cause the scanned high energy beam to impinge the bulk material surface at an angle of less than about 4 degrees from normal.

21. The system of claim 16 wherein the end station is configured to physically translate the bulk material along at least one axis during exposure to the ion beam.

22. The system of claim 16 wherein the HEBT section further comprises a beam expander.

23. The system of claim 16 wherein the linear accelerator comprises RFQ, QFI, RFI, and/or DTL elements.

24. A method of fabricating a free standing film from a bulk material, the method comprising:
exposing a surface of the bulk material to a high energy beam of ions generated by an ECR ion source coupled to a RFQ linear accelerator, such that hydrogen ions from the beam are implanted to a depth of about 20 microns or greater into the bulk material; and
cleaving the free-standing film from the bulk material at the depth.

25. The method of claim 24 wherein the beam has an energy of between about 0.5 and 7 MeV.

26. The method of claim 24 further comprising scanning the high energy beam across the surface of the bulk material.

27. The method of claim 24 further comprising translating the bulk material along at least one axis during the exposing.

28. An apparatus comprising:
an ECR ion source;
a low energy beam transport (LEBT) section comprising an Einzel lens and having an inlet in vacuum communication with the ECR ion source;
a linear accelerator section comprising three successive RFQ stages to elevate a beam of hydrogen ions outlet from the LEBT section to an energy of between about 0.5 and 7 MeV;
a high energy beam transport (HEBT) section in vacuum communication with an outlet of the linear accelerator section, the HEBT section comprising a beam scanner; and
an end station configured to translate a surface of a bulk material along an axis while the surface is exposed to the scanned high energy beam.
